(19) United States
(12) Patent Application Publication
(10) Pub. No.: US 2007/0151789 A1
(43) Pub. Date: Jul. 5, 2007

(54) Automatic motorcycle

(75) Inventors: Garth Bracy, Long Lake, MN (US); Greg Brew, Minnetonka, MN (US); Michael M. Song, Maple Grove, MN (US); John W. Callahan, St. Paul, MN (US)

Correspondence Address: BAKER & DANIELS LLP, 300 NORTH MERIDIAN STREET, SUITE 2700, INDIANAPOLIS, IN, 46204, US

(73) Assignee: Polaris Industries Inc., Medina, MN (US)

(21) Appl. No.: 11/636,077

(22) Filed: Dec. 8, 2006

Related U.S. Application Data
(60) Provisional application No. 60/748,637, filed on Dec. 8, 2005.

(51) Int. Cl. B62K 11/00

(52) U.S. Cl. 180/219

(57) ABSTRACT

An automatic motorcycle is comprised of a frame, an engine, an automatic transmission such as a continuously variable transmission (CVT) which drives a rear wheel through a shaft drive. The motorcycle includes a front compartment provided within an upper fairing having a compartment door which opens to access the compartment. The handlebars extend through the compartment door and raises with the compartment door through a steering linkage to the motorcycle steering mechanism.

This application claims the benefit of U.S. Provisional Patent Application Ser. No. 60/748,637 filed Dec. 8, 2005, the complete disclosure of which is hereby expressly incorporated by reference.

### FIELD OF THE INVENTION

The invention is directed to an automatic transmission motorcycle.

### BACKGROUND OF THE INVENTION

The motorcycle/scooter marketplace is increasing in the U.S. and globally, with the scooter market outpacing the motorcycle market in an increasing rate year over year. One of the reasons for the increased scooter popularity is its ease of use, that is no gear changing, together with its convenience of use. At the same time, motorcycle riders, particularly those having motorcycles in the “cruiser” class, like the ride, feel and comfort of the cruiser type motorcycle. Likewise, riders like the look of a “Sport Motorcycle” with the sleek lines and styling.

What would be desirable is to have a ride and feel of a cruiser motorcycle with the convenience and easy riding characteristics of a scooter, while at the same time have the look and styling of a Sport motorcycle.

### SUMMARY OF THE INVENTION

An automatic motorcycle is disclosed herein, comprising a frame; an engine mounted to the frame; a continuously variable transmission (CVT) operatively coupled to the engine; and a drive assembly intermediate the CVT and a driven wheel.

The drive assembly may be comprised of a transmission and a drive mechanism intermediate the transmission and the driven wheel. The frame may be comprised of rearwardly extending tubes which intersect a cross tube. The engine may be mounted forward of the cross tube, and the transmission is mounted intermediate the rearwardly extending tubes and the cross tube.

The drive mechanism may be comprised of a first drive shaft within the cross tube, driven by the transmission. The drive mechanism may further comprise a single sided swing arm, rotatably coupled to the cross tube. The single sided swing arm may comprise a support arm for supporting a wheel of the motorcycle, and a second drive shaft extending between the drive shaft and driven wheel. which comprises a frame, an engine mounted to the frame, a continuously variable transmission (CVT) operatively coupled to the engine, and a drive mechanism intermediate the CVT and a driven wheel.

In another embodiment, a motorcycle comprises a frame; a steering mechanism attached to a front end of the frame, comprising a steering column and handle bars; a seat attached to a rear end portion of the frame; and a front storage compartment formed above the frame, adjacent and forward of said seat.

The motorcycle may further comprise a compartment lid which opens towards said steering column. The handle bars and steering column may extend through the compartment lid, the steering column being longitudinally extendable as the compartment lid opens. The compartment has a volume profiled to store two adult sized helmets.

In another embodiment, a motorcycle comprises a frame; a steering mechanism attached to the frame, comprising a steering column and handle bars; a front panel through which said steering column extends; and the steering column being longitudinally extendable as the front panel portion is lifted.

The motorcycle may further comprise a front storage compartment formed above the frame, adjacent and forward of said seat. The front panel may be defined as a compartment lid to the compartment. The handle bars and steering column may extend through the compartment lid, the steering column being longitudinally extendable as the compartment lid opens. The compartment has a volume profiled to store two adult sized helmets.

In another embodiment, a motorcycle comprises a frame; an engine mounted to the frame; a single sided swing arm coupled to the frame at one end, and a rear axle at the opposite end; and a drive train coupled to the engine, and extending at least partially through the single sided swing arm to drive a rear driven wheel.

The drive-train may comprise a continuously variable transmission (CVT) operatively coupled to the engine; and a drive assembly intermediate the CVT and a driven wheel. The drive assembly may be comprised of a transmission and a drive mechanism intermediate the transmission and the driven wheel. The frame may be comprised of rearwardly extending tubes which intersect a cross tube. The engine may be mounted forward of the cross tube, and the transmission is mounted intermediate the rearwardly extending tubes and the cross tube.

The drive mechanism may be comprised of a first drive shaft within the cross tube, driven by the transmission. The drive mechanism may further comprise a single sided swing arm, rotatably coupled to the cross tube. The single sided swing arm may comprise a support arm for supporting a wheel of the motorcycle, and a second drive shaft extending between the drive shaft and driven wheel.

In yet another embodiment, a motorcycle comprises a frame; an engine mounted to the frame; a front fairing portion; a fuel tank mounted beneath the front fairing portion, with a cap accessible through the front fairing portion to a top of the fuel tank.

The motorcycle may further comprise a kickstand on one side of the motorcycle. The cap may be on the opposite side as the kickstand. The cap is accessible behind a hinged door on an outside of the fairing. The door may be designed as an emblem. The top of the fuel tank is positioned at a vertical position at or below a vertical midpoint of the motorcycle.

### BRIEF DESCRIPTION OF THE DRAWINGS

FIG. 1 is a right hand side view of the motorcycle of the present disclosure;

FIG. 2 is a left hand side view of the motorcycle of the present disclosure;

FIG. 3 is a rear perspective view of the left hand side;

FIGS. 4 and 5 are front perspective views of the motorcycle of the present disclosure;

FIGS. 6 and 7 are rear views of the motorcycle of the present disclosure;

FIG. 8 is an enlarged view of the portion denoted in FIG. 1;

FIG. 9 is an enlarged perspective view of the handlebar portion and storage compartment;

FIG. 10 is an enlarged perspective of the seat portion and rear tire;

FIG. 11 is a perspective view of the frame and forward fork of the motorcycle of the present disclosure;

FIG. 12 is an enlarged view of the single sided swing arm shown in FIG. 1;

FIG. 13 is a perspective view showing a view similar to that of FIG. 11 showing the storage compartment in phantom, with helmets residing on a storage compartment platform;

FIG. 14 is a side perspective view of the present disclosure showing the seat and front fairing installed with the compartment door and handlebars removed;

FIG. 15 shows a partially fragmented perspective view of the drive train;

FIG. 16 shows the entire drive train taken from the left hand side perspective;

FIG. 17 shows a rear perspective view of the motorcycle of the present disclosure showing the storage compartment lid raised together with the handlebars;

FIG. 18 shows a diagrammatical view of the motorcycle of the present disclosure with the outline of the motorcycle showing the front frame portion together with the handlebars, with the motorcycle outlined in phantom;

FIG. 19 shows a layout of the various components with the motorcycle outline partially in phantom;

FIG. 20 shows a view similar to that of FIG. 19 showing an alternate fuel tank;

FIGS. 21 and 22 show diagrammatical sketches of the storage compartment lid and handlebars in the lowered and raised positions, respectively;

FIG. 23 shows a further embodiment of the handlebars, and steering linkage with the storage compartment lid in a raised position; and

FIG. 24 shows a right perspective view with the gas cap opened.

### DETAILED DESCRIPTION OF THE EMBODIMENTS

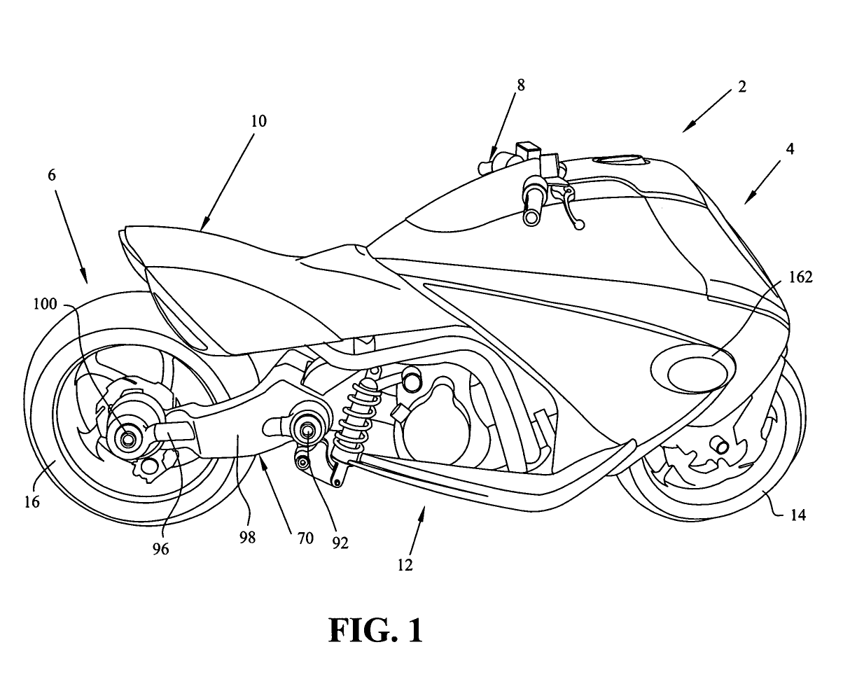

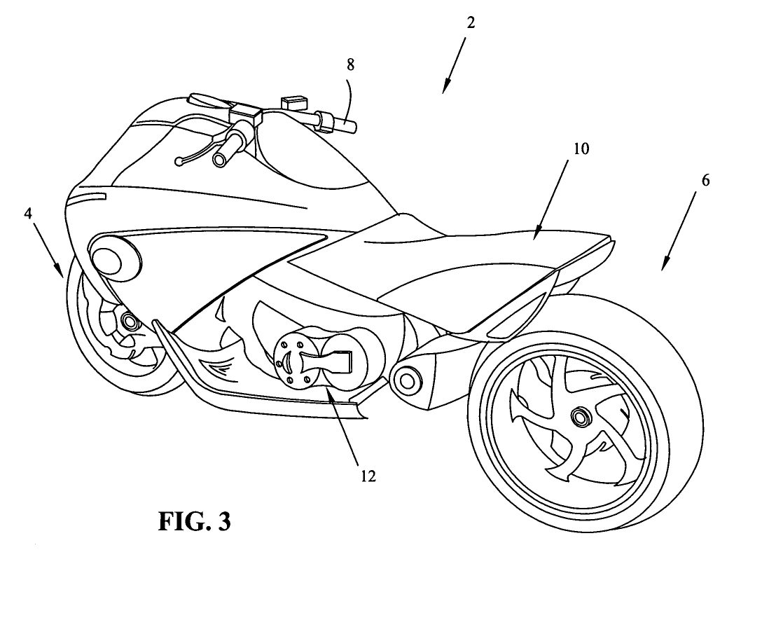

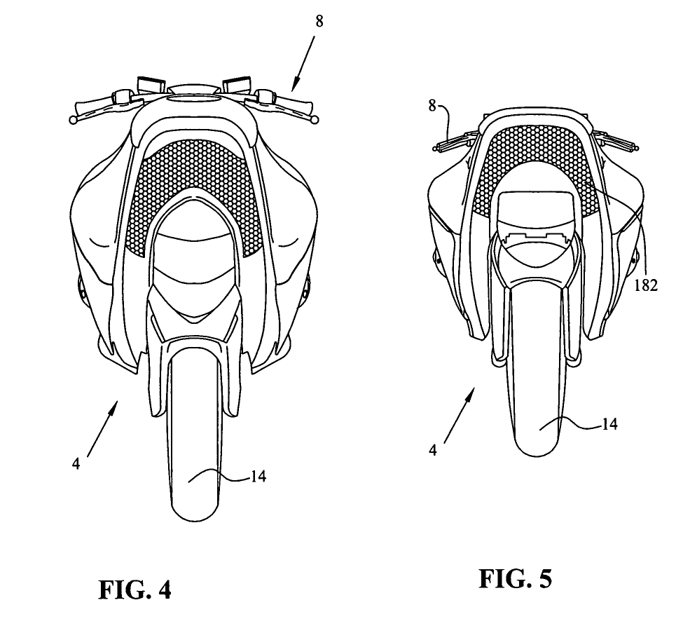

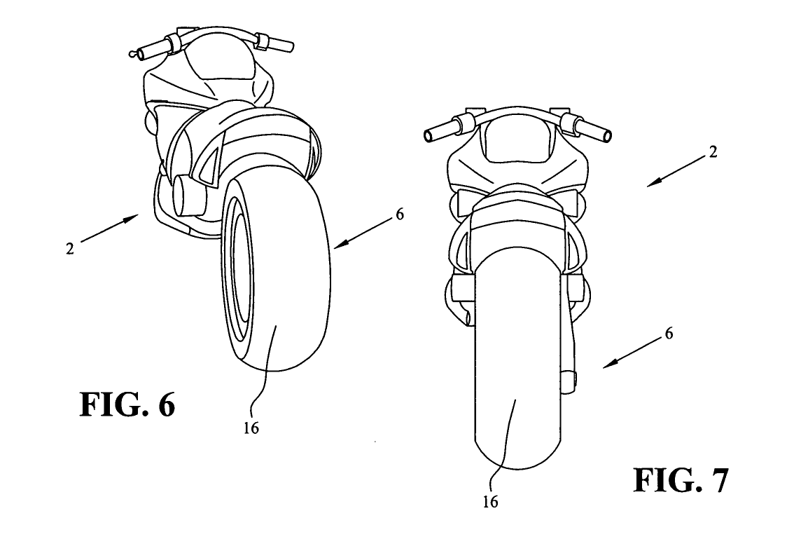

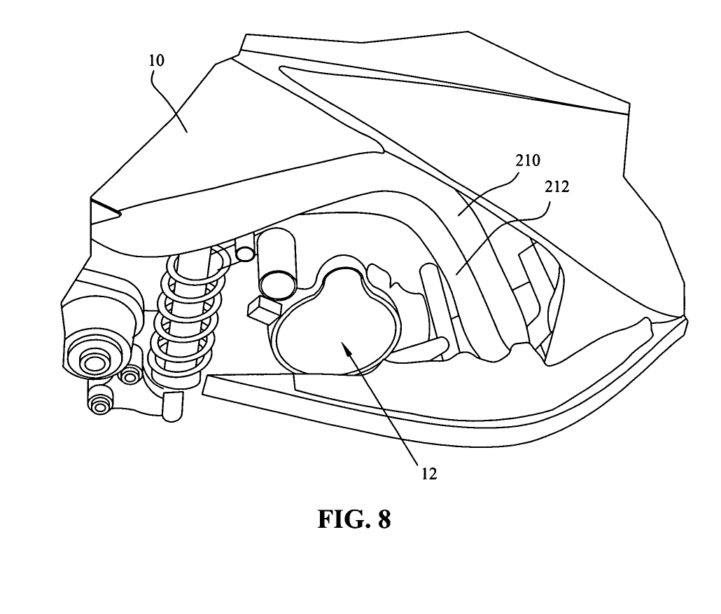

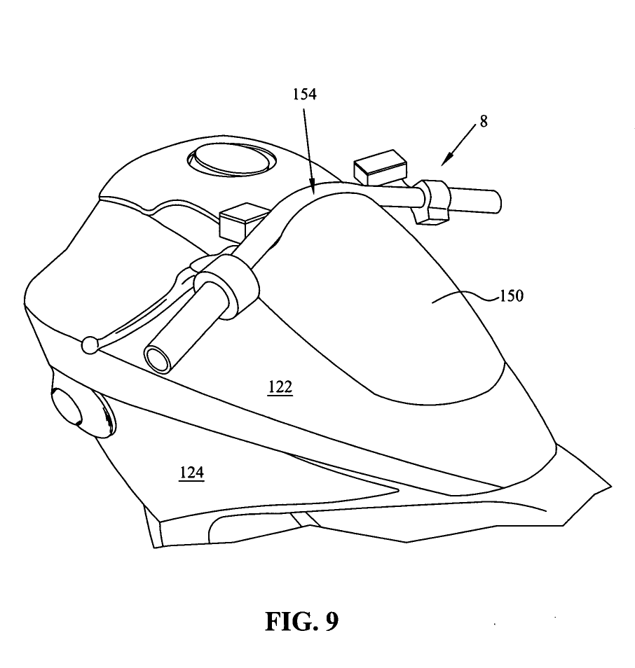

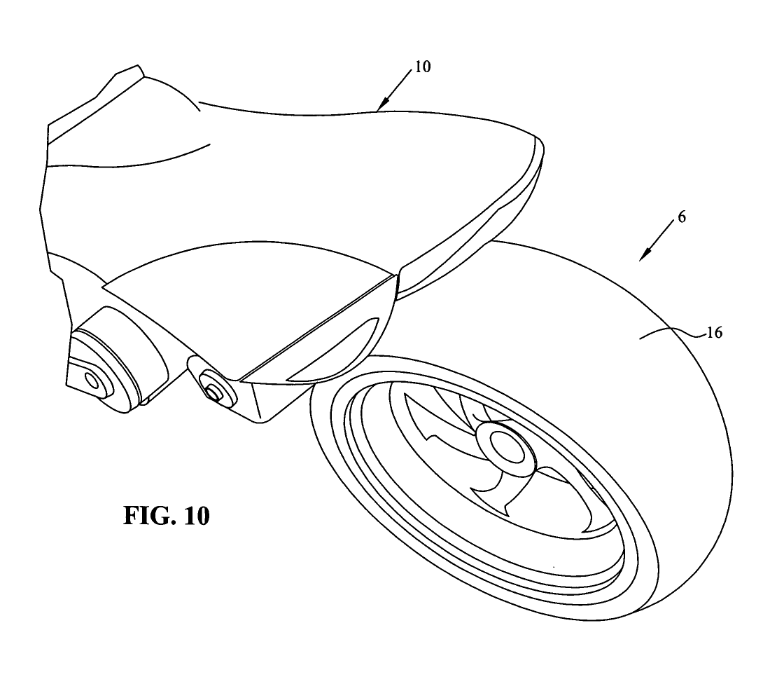

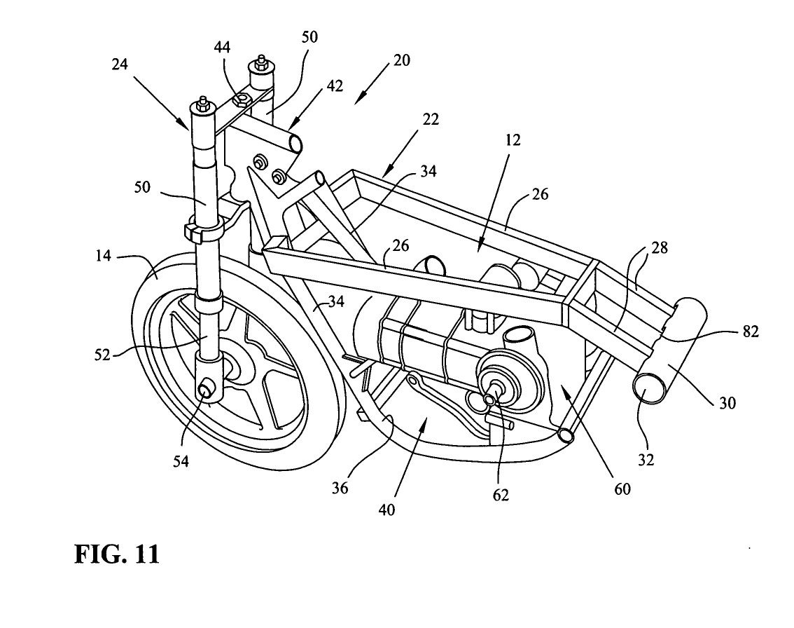

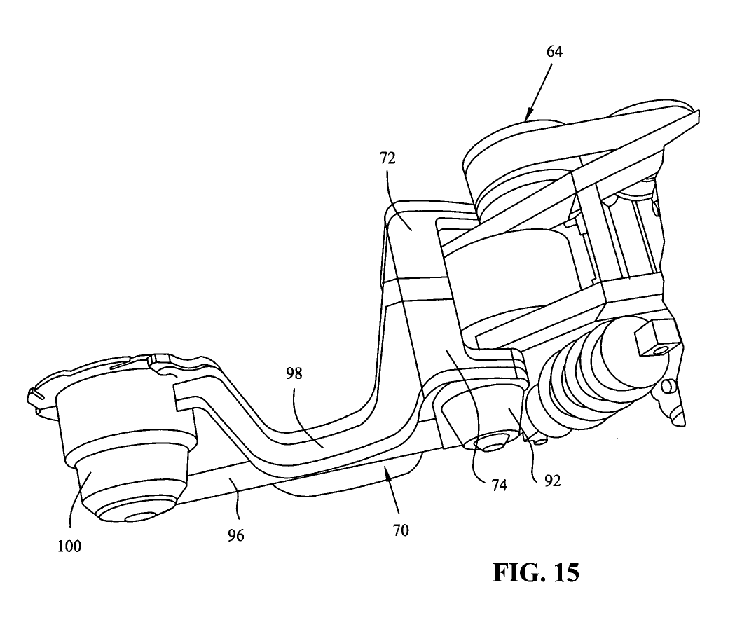

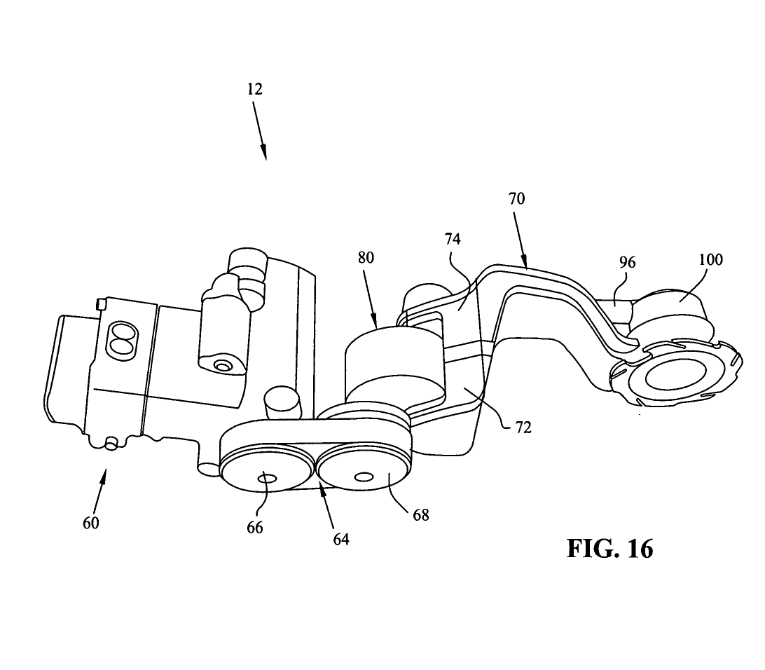

With respect first to FIGS. 1, 2 and 3, a motorcycle 2 according to the present embodiment will be disclosed. As shown in FIGS. 1-3, the motorcycle 2 generally includes a front end 4, a rear end 6, a steering portion 8, a seat at 10 and a drive train 12. Front end 4 includes front steering tire 14, whereas rear portion 6 includes a driven tire 16. Front end portion 4 and front steering tire 14 are shown more clearly in FIGS. 4 and 5. Rear portion 6 and driven tire 16 are shown more clearly in FIGS. 6 and 7. An enlarged view of a portion of the drive train 12 is shown in FIG. 8, whereas an enlarged view of the drive train 12 is shown in FIGS. 15 and 16. A steering mechanism 8 is shown more clearly in FIG. 9. Finally an enlarged view of the seating portion 10 is shown more clearly in FIG. 10. With respect now to FIGS. 11-16, the motorcycle internal structure and drive train 12 will be described in greater detail.

With respect first to FIG. 11, the motorcycle further comprises a frame which is generally shown at 20. Frame 20 includes an upper frame portion or backbone 22, and a steering portion shown at 24 is attached to the upper frame portion 22. Frame portion 22 generally comprises two rearwardly extending tubes 26 which generally form the structure referred to as the backbone 22. The tubes 26 lead into downwardly extending tubes 28. Tubes 28 are thereafter connected at their ends by a transverse cross tube generally shown at 30. Cross tube 30 is shown as having an internal bore at 32 which will be described further herein. The forward end of the tubes 26 are welded to downwardly extending frame members 34 which curve to extend generally horizontally to lower tube portions 36. Tubes 36 and 26 generally form there between an engine mounting bay 40. Tubes 34 are connected to an upper pivot portion shown generally at 42 which would include a downwardly extending pivot pin portion 44.

Steering portion 24 is pivotally connected at pivot pin 44 to move clockwise and counterclockwise, about the pivot pin 44, as is well known in the art, to steer front tire 14. Steering portion 24 includes dual down tubes 50 through which forks 52 extend. The forks 52 connect to front tire 14 by an axle assembly at 54, as is also well known in the art.

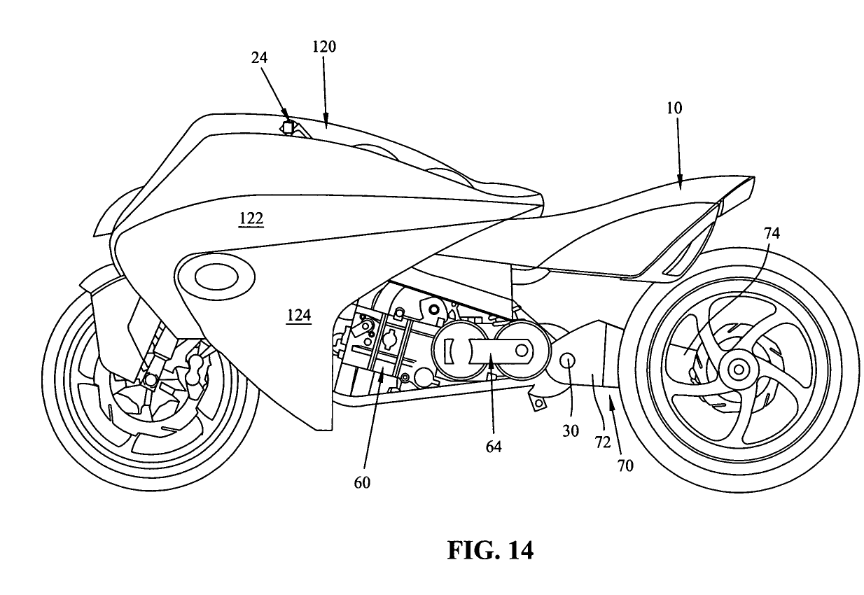

With reference still to FIG. 11, an engine 60 is shown mounted within the engine mounting bay 40, and engine is shown having an output drive shaft at 62. While the engine could be any type of drive mechanism, the engine shown is a Polaris 700cc engine of the same type used in our SPORTSMAN ATV line. As shown in FIGS. 14, 15 and 16, output shaft 62 (FIG. 11) is operatively coupled to drive train 12, and in particular to mechanism 64, typically referred to as a continuously variable transmission (CVT). The CVT 64 is a belt driven mechanism which varies the drive radius of a belt on the drive and driven pulleys in order to vary the output ratio. While the belt and the drive and driven pulleys are not specifically shown, it should be appreciated that the drive pulley is coupled directly to output driveshaft 62 (FIG. 11) and positioned in housing portion 66 of CVT 64 (FIG. 16), and that a driven pulley is located in housing portion 68 of CVT 64 (FIG. 16) and is driven by the drive pulley. It is should also be appreciated that the CVT 64 is similar in concept to that disclosed in our U.S. Pat. No. 6,149,540 which is incorporated in its entirety herein.

The driven gear of CVT 64 is thereafter coupled to transmission 80 which could be geared in any manner consistent with the various drive ratios and top speeds desired. The output of transmission 80 drives the rear driven tire 16 through a drive shaft mechanism as described below.

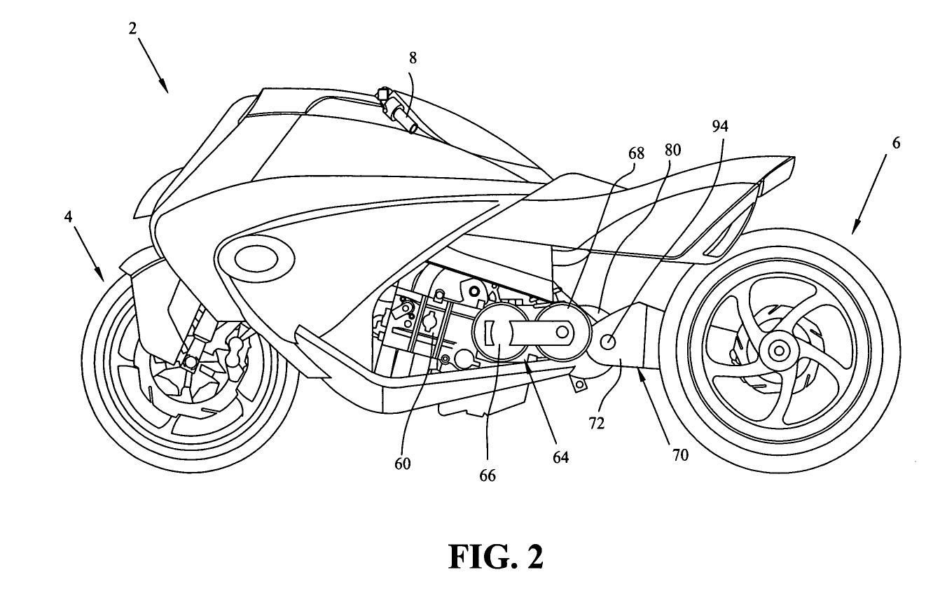

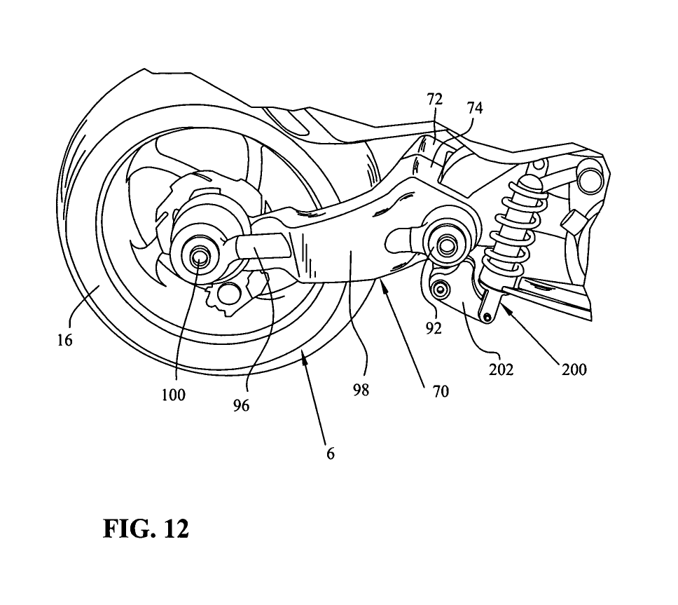

With reference to FIGS. 14-16, a single sided swing arm is shown generally at 70 having a first half 72 and a second half 74, where the two halves include flanges which straddle and flank cross tube 30 as best shown in FIG. 14. As best shown in FIG. 16, CVT 64 is operatively coupled to transmission 80 which also straddles cross tube 30 and is flanked by single sided swing arm 70. The transmission output would have a helical or bevel gear which extends through a cutout or notch 82 (FIG. 11) and a jack shaft (not shown) runs through cross tube 30 and is held at its end by bearings (not shown) in bearing caps 92, 94 as best shown in FIGS. 1 and 2. The jack shaft would itself include a helical or bevel gear adjacent to bearing cap 92 which then drives a drive shaft (not shown) within tube 96 which extends through longitudinally extending arm portion 98 of single sided swing arm 70. Tube 96 extends to a wheel mounted gear set 100 which would drive rear wheel 6 on a rear axle, as best shown in FIG. 12.

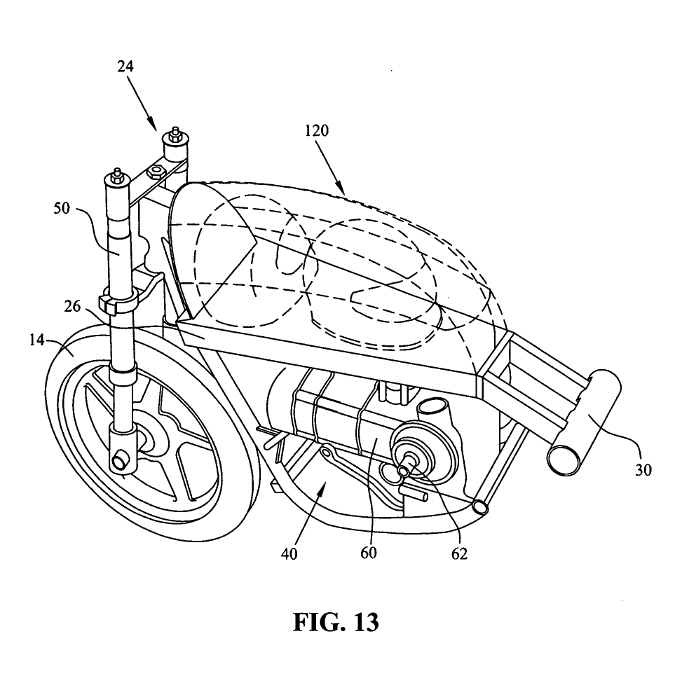

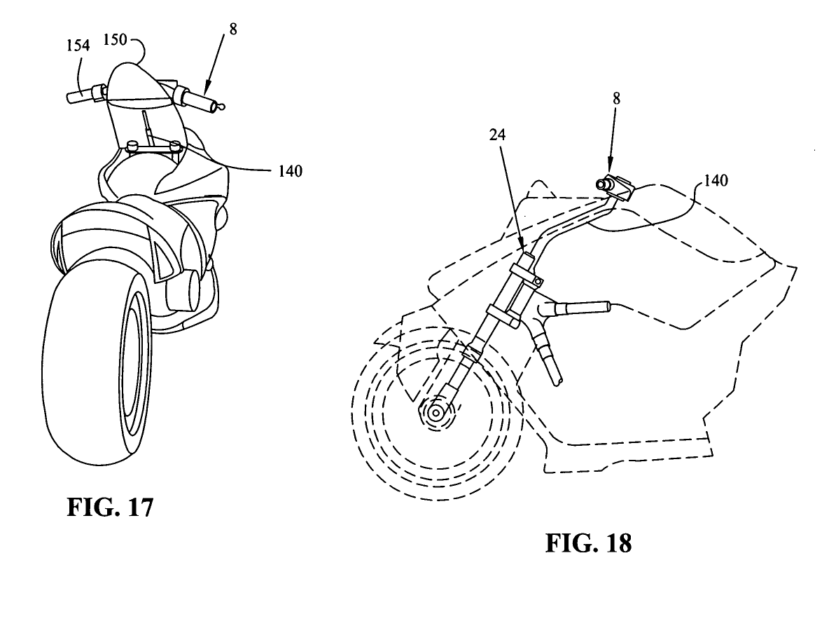

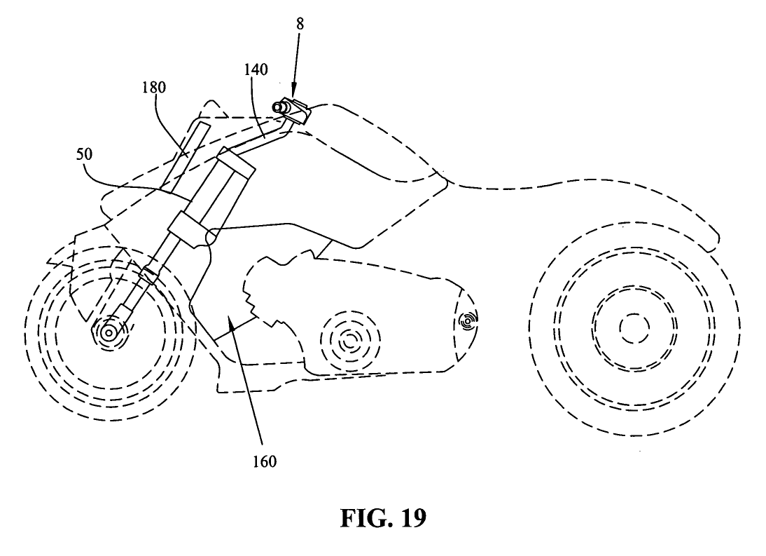

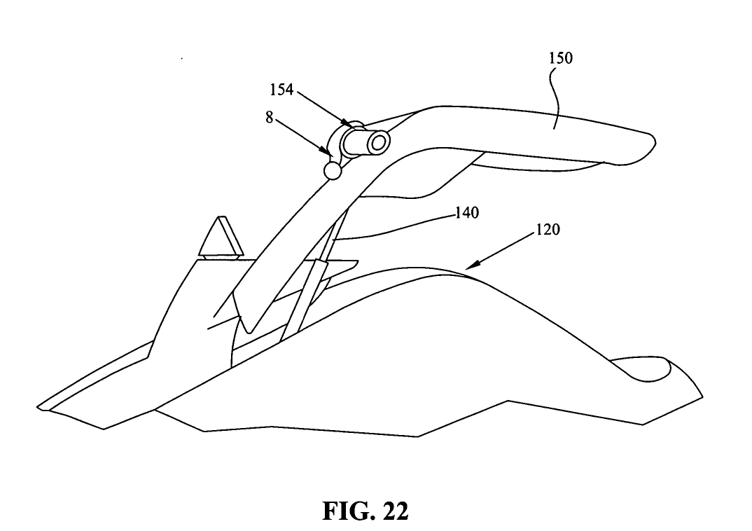

With reference now to FIG. 13 and 14, a compartment 120 is defined above tubes 26 and is shown in phantom in FIG. 13 as being profiled to receive two full size face helmets in storage. This outline is replicated in FIG. 14 where the compartment is defined by upper fairing 122, and in combination with lower fairing 124 surround steering mechanism 24 and substantially cover tubes 26, as shown best in FIG. 14. As shown in FIGS. 17-22, steering portion 8 is shown as further including a moveable handlebar column, shown generally at 140, which could take on any suitable configuration. Regardless of the configuration, the steering column 140 is moveable along a longitudinal axis with the opening of a compartment door 150. The compartment door 150, steering column 140, and handle bars 154 are moveable together to an open position, shown in FIG. 17. The longitudinal movement could be created by telescopic tubes having any type of interlocking configuration or could be comprised of a moveable universal joint. Suffice it to say that the compartment door 150 has a closed position, as shown in FIG. 21, where the steering portion 8 is positioned in its operable position. In addition, the door 150 is moveable to an open position, as shown in FIG. 22, wherein both the handlebar 154 and compartment door 150 open to allow access to compartment 120.

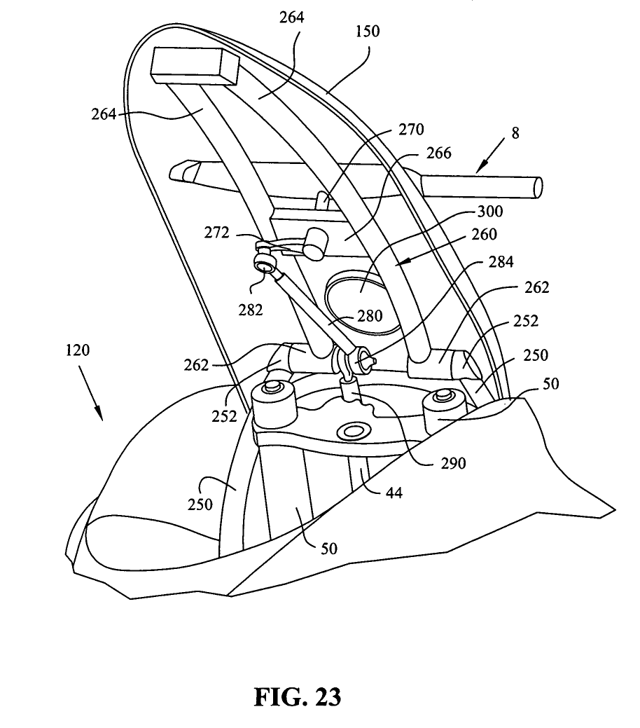

With reference now to FIG. 23, a further embodiment of the compartment and steering arrangement is shown. In this embodiment, frame tubes 250 extend upwardly to a position surrounding down tubes 50 where down tubes 50 pivot around pivot pin 44, relative to frame tubes 250. Frame tubes 250 could be an extension of tubes 26 or could be fixedly retained thereto. Upper ends of frame tubes 250 include pivot mounts 252 which retain a pivotal frame member 260 thereto. Frame member 260 includes pivot members 262 pivotally joined to members 252, frame ribs 264 and steering plate 266. Steering assembly 8 includes steering pin 270 extending through steering plate 266 to which a steering arm 272 is fixedly attached, and rotates with the rotation of the handlebars. The assembly further includes a steering link 280 having a first ball joint end 282 fixed to steering arm 272 and second ball joint end 284 fixed to a steering pin 290. Thus in operation, handlebars are turned clockwise or counterclockwise which results in the rotation of steering arm 272 and link 280 to act upon steering pin 290. It should be appreciated that compartment lid 150 is attached to frame 260, which allows the pivotal frame 260 to pivot towards and away from the compartment and yet maintain the steering operation with the steering assembly 8 lifting with the compartment lid 150.

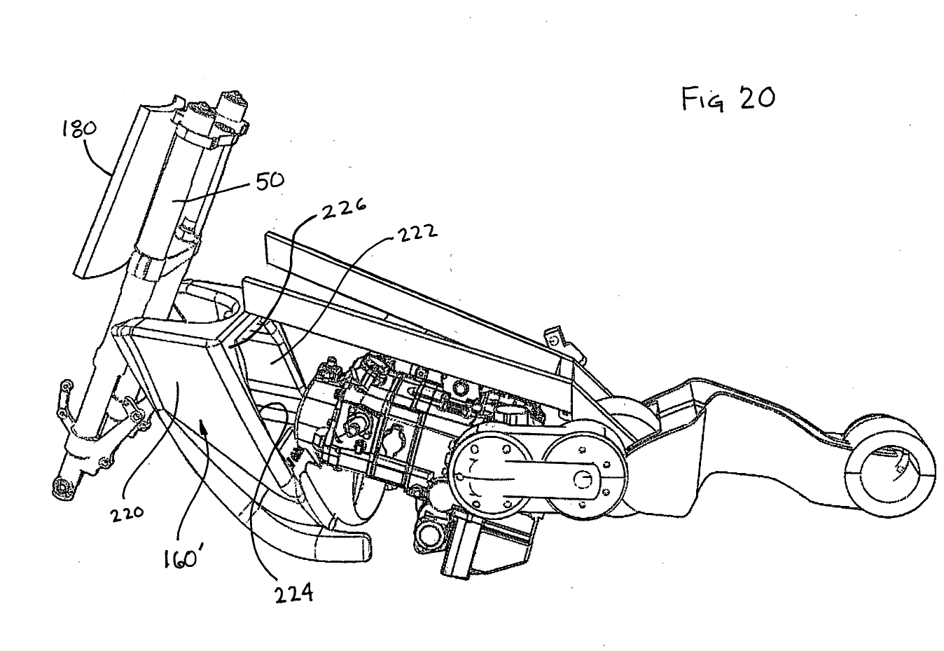

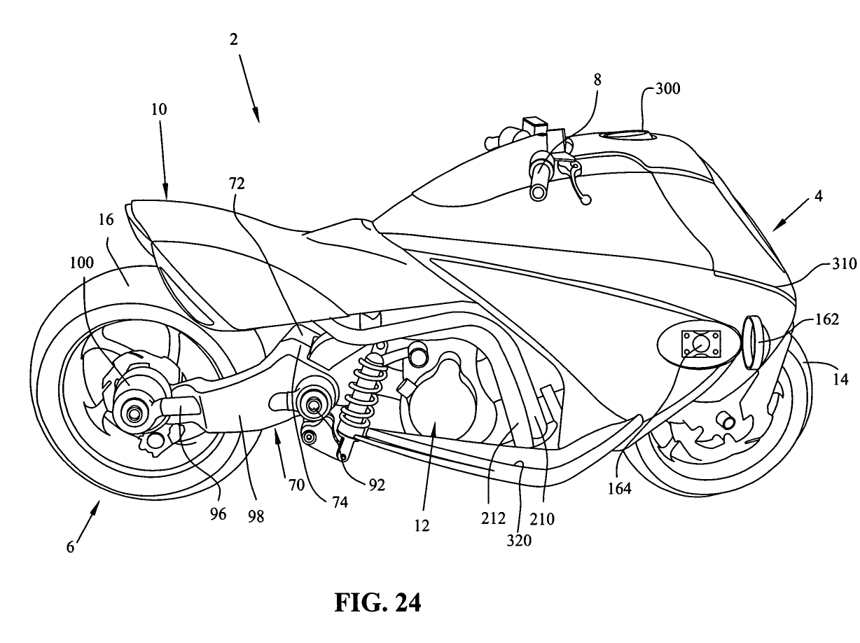

As shown in FIG. 19, a bladder fuel tank is shown positioned forward of the engine which could comprise a blow molded container 160 for retaining the fuel. Access to the fuel tank is through the right side emblem 162 as shown in FIG. 24. In this manner, when the motorcycle is positioned in a stationary position with the kickstand down, the fuel tank 160 can be filled from the right hand side of the vehicle through opening 164, where the level of the fuel will be justified towards the left hand side of the vehicle in order to properly fill the bladder tank 160.

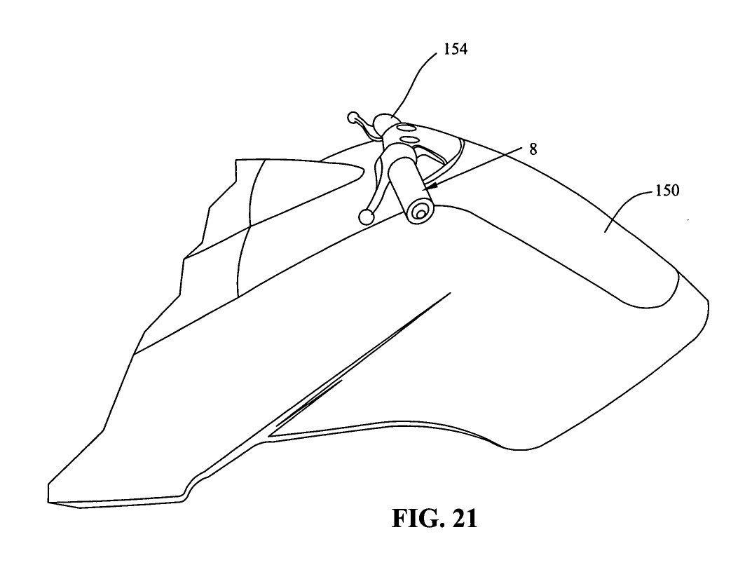

As also shown in FIG. 19, an oil cooler or radiator 180 is positioned in front of the down tubes 50, and is accessible for air flow through an opening 182 (FIG. 5), for providing air flow across the heat exchanger to cool the oil. Alternatively, and as shown in FIG. 20, an alternate fuel tank 160′ is shown having a U-shaped structure for clearance of the down tubes 50, with tank portions 220 and 222 being positioned on opposite sides of an opening 224. Fuel tank 160′ also includes a rear surface, against which a radiator may be attached, with air flow coming through the opening 224.

Other features of the present embodiment, include a shock absorber assembly 200 (FIG. 12) attached to tubes 26 at an upper end, and to a pivot link 202, at a lower end. Pivot link 202 is pivotally connected to single sided swing arm 70, as shown best in FIG. 12. Also, as shown in FIG. 8, dual exhaust is provided by exhaust pipes 210, 212 which extends rearwardly and up under seat mechanism 10.

Finally, and with reference to FIG. 24, an LCD instrument panel 300 is provided which opens with the compartment (as viewed in FIG. 23). This instrument panel would include gauges such as engine speed, vehicle speed, fuel capacity, etc. LED turn signals 310 are also provided which flair rearwardly along the lines of the fairings. Floor board 320 is also provided which again are flaired with the lines of the fairings and provide for a full width footrest.

In should be understood that many modifications are possible, and combinations and sub combinations of the components are also possible. For example, while the embodiments were described only with respect to a CVT, it should be appreciated that many of the features herein could be used with a gear shift transmission. Also, the engine is described above as a fuel driven engine, but it could also be an electrical battery driven motor.

What is claimed is:

1. An automatic motorcycle, comprising:
a frame;
an engine mounted to the frame;
a continuously variable transmission (CVT) operatively coupled to the engine; and
a drive assembly intermediate the CVT and a driven wheel.

2. The automatic motorcycle of claim 1, wherein the drive assembly is comprised of a transmission and a drive mechanism intermediate the transmission and the driven wheel.

3. The automatic motorcycle of claim 1, wherein frame is comprised of rearwardly extending tubes which intersect a cross tube.

4. The automatic motorcycle of claim 3, wherein the engine is mounted forward of the cross tube, and the transmission is mounted intermediate the rearwardly extending tubes and the cross tube.

5. The automatic motorcycle of claim 4, wherein the drive mechanism comprises a first drive shaft within the cross tube, driven by the transmission.

6. The automatic motorcycle of claim 5, wherein the drive mechanism further comprises a single sided swing arm, rotatably coupled to the cross tube.

7. The automatic motorcycle of claim 6, wherein the single sided swing arm comprises a support arm for supporting a wheel of the motorcycle, and a second drive shaft extending between the drive shaft and driven wheel.

8. A motorcycle, comprising:
a frame;
a steering mechanism attached to a front end of the frame, comprising a steering column and handle bars;
a seat attached to a rear end portion of the frame; and
a front storage compartment formed above the frame, adjacent and forward of said seat.

9. The motorcycle of claim 8, further comprising a compartment lid which opens towards said steering column.

10. The motorcycle of claim 9, wherein the handle bars and steering column extend through the compartment lid, the steering column being longitudinally extendable as the compartment lid opens.

11. The motorcycle of claim 8, wherein the compartment has a volume large enough to store two adult sized helmets.

12. A motorcycle, comprising:
a frame;
a steering mechanism attached to the frame, comprising a steering column and handle bars;
a front panel through which said steering column extends; and
the steering column being longitudinally extendable as the front panel portion is lifted.

13. The motorcycle of claim 12, further comprising a front storage compartment formed above the frame, adjacent and forward of a seat.

14. The motorcycle of claim 13, wherein the front panel is defined as a compartment lid to the compartment.

15. The motorcycle of claim 14, further wherein the handle bars and steering column extend through the compartment lid, the steering column being longitudinally extendable as the compartment lid opens.

16. The motorcycle of claim 13, wherein the compartment has a volume profiled to store two adult sized helmets.

17. A motorcycle, comprising:
a frame;
an engine mounted to the frame;
a single sided swing arm coupled to the frame at one end, and a rear axle at the opposite end; and
a drive train coupled to the engine, and extending at least partially through the single sided swing arm to drive a rear driven wheel.

18. A motorcycle according to claim 17, wherein the drive-train comprises a continuously variable transmission (CVT) operatively coupled to the engine; and a drive assembly intermediate the CVT and a driven wheel.

19. The automatic motorcycle of claim 18, wherein the drive assembly is comprised of a transmission and a drive mechanism intermediate the transmission and the driven wheel.

20. The automatic motorcycle of claim 19, wherein the frame is comprised of rearwardly extending tubes which intersect a cross tube.

21. The automatic motorcycle of claim 20, wherein the engine is mounted forward of the cross tube, and the transmission is mounted intermediate the rearwardly extending tubes and the cross tube.

22. The automatic motorcycle of claim 21, wherein the drive mechanism comprises a first drive shaft within the cross tube, driven by the transmission.

23. The automatic motorcycle of claim 22, wherein the single sided swing arm is rotatably coupled to the cross tube.

24. The automatic motorcycle of claim 23, wherein the single sided swing arm comprises a support arm for supporting a wheel of the motorcycle, and a second drive shaft extending between the drive shaft and driven wheel.

25. A motorcycle, comprising:
a frame;
an engine mounted to the frame;
a front fairing portion;
a fuel tank mounted beneath the front fairing portion, with a cap accessible through the front fairing portion to a top of the fuel tank.

26. The motorcycle of claim 25, further comprising a kickstand on one side of the motorcycle.

27. The motorcycle of claim 26, wherein the cap is on the opposite side as the kickstand.

28. The motorcycle of claim 27, wherein the cap is accessible behind a hinged door on an outside of the fairing.

29. The motorcycle of claim 28, wherein the door is designed as an emblem.

30. The motorcycle of claim 25, wherein the top of the fuel tank is positioned at a vertical position at or below a vertical midpoint of the motorcycle.
